(19) United States
(12) Patent Application Publication
(10) Pub. No.: US 2016/0246429 A1
(43) Pub. Date: Aug. 25, 2016

(54) METHOD AND SYSTEM OF DETECTING TOUCH OPERATION ON TOUCH SCREEN, AND TOUCH DISPLAY DEVICE

(71) Applicants: Boe Technology Group Co., Ltd., Bejing (CN); Hefei Xinsheng Optoelectronics Technology Co. Ltd., Hefei, Anhu (CN)

(72) Inventors: Tao MA, Beijing (CN); Hengbin LI, Beijing (CN)

(21) Appl. No.: 14/437,116

(22) PCT Filed: Aug. 25, 2014
(86) PCT No.: PCT/CN2014/085120

§ 371 Date: Apr. 20, 2015

(30) Foreign Application Priority Data
Mar. 31, 2014 (CN) 201410126657.2

(51) Int. Cl. G06F 3/041; G06F 3/044

(52) U.S. Cl. CPC G06F 3/0416; G06F 3/044

(57) ABSTRACT

The present invention discloses a detection method and system for detecting whether or not a touch screen is touched, and a touch display device, for precisely detecting whether or not the touch screen is touched. The method comprises: controlling the touch screen to output a frame image, using pre-established correspondences between each gray scale and the correction data for the gray scale to convert gray scale of each sub-pixel region in the image into correction data for the gray scale, and using the obtained correction data to constitute a correction data table, the correction data table comprising correspondences between each sub-pixel region in the image and correction data; outputting a touch scan signal to a touch drive electrode line, and receiving a voltage signal outputted from a touch sensing electrode line, determining the sub-pixel region corresponding to the position coordinates, determining the correction data corresponding to the sub-pixel region through lookup in the correction data table, using the correction data to correct voltage waveform data corresponding to the voltage signal, and judging whether or not the touch screen is touched based on the corrected voltage waveform data.

### FIELD OF THE INVENTION

The present invention relates to the field of display technologies, and particularly, to a method and a system of detecting a touch operation on a touch screen and a touch display device using the system.

### BACKGROUND OF THE INVENTION

In prior arts, when compared to a conventional out-cell capacitive touch screen arrangement, a touch substrate may be omitted in an in-cell capacitive touch screen, so that the whole display assembly can be made much thinner and lighter. A schematic structural diagram of a liquid crystal display screen based on the in-cell touch technology is illustrated in FIG. 1, touch drive electrodes Tx and touch sensing electrodes Rx are formed on a glass substrate on a side of an array substrate of a liquid display panel, wherein each touch drive electrode line shares a same electrode line with a common electrode (Vcom) line; various parasitic capacitances and coupling capacitances will be generated between thin film transistor (TFT) display devices and touch drive electrodes and touch sensing electrodes of the capacitive touch screen having an in-cell arrangement, so that when the liquid crystal display screen is operating, alternations of various voltages on the TFT(s) will produce crosstalk to signals on the touch drive electrodes Tx and the touch sensing electrodes Rx, which has a serious influence on touch effect. In FIG. 1, Gate 1, Gate 2, Gate n respectively represent gate scan lines for each row of pixels, Data 1, Data 2, Data n respectively represent data scan lines for each column of pixels, C_{LC} represents a capacitance between liquid display panels, and Cs represents a storage capacitance.

Currently, a driving mode used in the in-cell touch technology is time-sharing driving mode, wherein touch control is conducted during a blank period between two frames. In a touch operation, voltages outputted to the TFT both from a source driver and from a gate driver stop changing, at this time, crosstalk to signals on the touch drive electrodes Tx and touch sensing electrodes Rx caused by driving signals is weakest. An operation flowchart of driving an in-cell liquid crystal screen is illustrated in FIG. 2. Wherein, when a touch (Touch) control integrated circuit (IC) performs an initialization scan operation, a liquid crystal panel has not been driven, and quantity of electric charges on the storage capacitance Cs is zero. After finishing input of last row of gate (Gate) signals for each frame, the touch control integrated circuit performs a scan operation, and compares obtained data with data obtained during the initialization scan operation, so as to judge whether or not a touch operation occurs. However, when the touch control integrated circuit performs the scan operation, since the touch drive electrode line Tx shares a same electrode line with the common electrode line Vcom, electric charges on the storage capacitance Cs and other parasitic and coupling capacitances will result in crosstalk to signals. Thus, even when no touch operation occurs, a result of data comparison conducted by the touch control integrated circuit will change due to frame changes, thereby resulting in an erroneous judgment.

Considering the above, in the liquid crystal display screen based on in-cell touch technology in prior arts, it is difficult to precisely determine whether or not a touch operation occurs on the liquid crystal display screen.

Therefore, there is a need for a system and a method that can precisely determine whether or not a liquid crystal display screen is touched.

### SUMMARY OF THE INVENTION

In order to solve the above technical problems, the present invention provides a detection method and system for detecting whether or not a touch screen is touched and a touch display device using the system, so as to precisely detect whether or not the touch screen is touched.

In one aspect, an embodiment of the present invention provides a method for detecting a touch operation on a touch screen, and the method comprises:

controlling the touch screen to output a frame image, using pre-established correspondences between each gray scale and the correction data for the gray scale to convert gray scale of each sub-pixel region in the image into correction data for the gray scale, and using the obtained correction data to constitute a correction data table, the correction data table comprising correspondences between each sub-pixel region in the image and the correction data;

outputting a touch scan signal to a touch drive electrode line, and receiving a voltage signal outputted from a touch sensing electrode line coupling with the touch scan signal on the touch drive electrode line, the voltage signal being used to determine position coordinates of a possible touch position on the touch screen; and

determining the sub-pixel region corresponding to the position coordinates, determining the correction data corresponding to the sub-pixel region through lookup in the correction data table, using the correction data to correct voltage waveform data corresponding to the voltage signal, and judging whether or not the touch screen is touched based on the corrected voltage waveform data.

In the method of detecting a touch operation on a touch screen provided according to the embodiment of the present invention, the method may output, for example through a touch controller, a touch scan signal to a touch drive electrode line, receive a voltage signal outputted from a touch sensing electrode line coupling with the touch scan signal on the touch drive electrode line, and determine position coordinates on the touch screen that correspond to the voltage signal; the method may, for example through the touch controller, determine the sub-pixel region corresponding to the position coordinates, determining the correction data corresponding to the sub-pixel region through lookup in the correction data table, use the correction data to correct voltage waveform data corresponding to the voltage signal, and judge whether or not the touch screen is touched based on the corrected voltage waveform data. Thus, the method for detecting a touch operation on a touch screen provided according to the embodiment of the present invention can precisely detect whether or not the touch screen is touched, thereby effectively avoiding crosstalk on the touch signal caused by changes in voltage level in the TFT due to frame changes.

According to one embodiment of the present invention, the method further comprises a step of pre-establishing the correspondences between each gray scale and the correction data for the gray scale, the step comprising:

outputting a preset touch scan signal to a touch drive electrode line, receiving a reference voltage signal outputted from the touch sensing electrode line coupling with the preset touch scan signal on the touch drive electrode line, the reference voltage signal corresponding to a particular sub-pixel region, and converting the reference voltage signal into reference voltage waveform data, the reference voltage waveform data being used as reference data;

driving a certain sub-pixel of the touch screen through using a gray scale voltage for each gray scale, wherein a touch controller outputs the touch scan signal for each gray scale to the touch drive electrode line, and receives a gray scale voltage signal for the certain sub-pixel region outputted from the touch sensing electrode line coupling with the touch scan signal for each gray scale on the touch drive electrode line, so as to obtain the gray scale voltage signal for the certain sub-pixel region corresponding to each gray scale; and

converting the gray scale voltage signal for the certain sub-pixel region corresponding to each gray scale into gray scale voltage waveform data, and for each gray scale voltage waveform data, using a difference between the gray scale voltage waveform data and the reference voltage waveform data as correction data for the gray scale corresponding to the gray scale voltage waveform data so as to establish the correspondences between each gray scale and the correction data for the gray scale.

As such, through pre-establishing the correspondences between each gray scale and the correction data for the gray scale, the method can precisely detect whether or not the touch screen is touched, thereby effectively avoiding crosstalk on the touch signal caused by changes in voltage level in the TFT due to frame changes.

According to one embodiment of the present invention, the preset image is a black image or a white image.

When the preset image is a black image or a white image, it will be more convenient and simple in practical applications.

According to one embodiment of the present invention, the step of using the correction data to correct voltage waveform data corresponding to the voltage signal comprises: subtracting the correction data for the sub-pixel region corresponding to the position coordinates from the voltage waveform data corresponding to the voltage signal to obtain a difference, and using the difference as the corrected voltage waveform data.

As such, the touch controller subtracts the correction data for the sub-pixel region corresponding to the position coordinates from the voltage waveform data corresponding to the voltage signal to obtain a difference, and uses the difference as the corrected voltage waveform, and it will be more convenient and simple in practical detections.

According to one embodiment of the present invention, the step of judging whether or not the touch screen is touched based on the corrected voltage waveform data comprises:

determining that the touch screen is touched when the corrected voltage waveform data is greater than preset standard data.

As such, it is determined that the touch screen is touched when the corrected voltage waveform data is greater than the preset standard data, so that it will be more convenient and simple in practical detections.

In another aspect, an embodiment of the present invention further provides a system for detecting a touch operation on a touch screen, the system comprises a time schedule controller and a touch controller, wherein:

the time schedule controller is configured to control the touch screen to output a frame image, to use pre-established correspondences between each gray scale and the correction data for the gray scale to convert gray scale of each sub-pixel region in the image into correction data for the gray scale, and to use the obtained correction data to constitute a correction data table, the correction data table comprising correspondences between each sub-pixel region in the image and the correction data; and

the touch controller is configured to output a touch scan signal to a touch drive electrode line, and to receive a voltage signal outputted from a touch sensing electrode line coupling with the touch scan signal on the touch drive electrode line, the voltage signal being used to determine position coordinates of a possible touch position on the touch screen; and the touch controller is further configured to determine the sub-pixel region corresponding to the position coordinates, to determine the correction data corresponding to the sub-pixel region through lookup in the correction data table, to use the correction data to correct voltage waveform data corresponding to the voltage signal, and to judge whether or not the touch screen is touched based on the corrected voltage waveform data.

In the system for detecting a touch operation on a touch screen provided according to the embodiment of the present invention, the touch controller is configured to output a touch scan signal to a touch drive electrode line, and to receive a voltage signal outputted from a touch sensing electrode line coupling with the touch scan signal on the touch drive electrode line, the voltage signal being used to determine position coordinates of a possible touch position on the touch screen; and the touch controller is further configured to determine the sub-pixel region corresponding to the position coordinates, to determine the correction data corresponding to the sub-pixel region through lookup in the correction data table, to use the correction data to correct voltage waveform data corresponding to the voltage signal, and to judge whether or not the touch screen is touched based on the corrected voltage waveform data. Thus, the system for detecting a touch operation on a touch screen provided according to the embodiment of the present invention can precisely detect whether or not the touch screen is touched, thereby effectively avoiding crosstalk on the touch signal caused by changes in voltage level in the TFT due to frame changes.

According to one embodiment of the present invention, when pre-establishing the correspondences between each gray scale and the correction data for the gray scale,
the time schedule controller is further configured to control the touch screen to output a preset image after an initialization of the time schedule controller is finished; and
the touch controller is further configured to output a preset touch scan signal to a touch drive electrode line, to receive a reference voltage signal outputted from the touch sensing electrode line coupling with the preset touch scan signal on the touch drive electrode line, the reference voltage signal corresponding to a particular sub-pixel region, and convert the reference voltage signal into reference voltage waveform data, the reference voltage waveform data being used as reference data; the touch controller is further configured to drive a certain sub-pixel of the touch screen through using a gray scale voltage for each gray scale, wherein the touch controller outputs the touch scan signal for each gray scale to the touch drive electrode line, and receives a gray scale voltage signal for the certain sub-pixel region outputted from the touch sensing electrode line coupling with the touch scan signal for each gray scale on the touch drive electrode line, so as to obtain the gray scale voltage signal for the certain sub-pixel region corresponding to each gray scale; and the touch controller is further configured to convert the gray scale voltage signal for the certain sub-pixel region corresponding to each gray scale into gray scale voltage waveform data, and for each gray scale voltage waveform data, use a difference between the gray scale voltage waveform data and the reference voltage waveform data as correction data for the gray scale corresponding to the gray scale voltage waveform data so as to establish the correspondences between each gray scale and the correction data for the gray scale.

As such, by establishing the correspondences between each gray scale and the correction data for the gray scale, it is possible to precisely detect whether or not the touch screen is touched, thereby effectively avoiding crosstalk on the touch signal caused by changes in voltage level in the TFT due to frame changes.

According to one embodiment of the present invention, when using the correction data to correct voltage waveform data corresponding to the voltage signal, the touch controller is configured to subtract the correction data for the sub-pixel region corresponding to the position coordinates from the voltage waveform data corresponding to the voltage signal to obtain a difference, and use the difference as the corrected voltage waveform data.

As such, since the touch controller is specifically used to subtract the correction data for the sub-pixel region corresponding to the position coordinates from the voltage waveform data corresponding to the voltage signal to obtain a difference, and use the difference as the corrected voltage waveform data, it will be more convenient and simple in practical detections.

According to one embodiment of the present invention, when judging whether or not the touch screen is touched based on the corrected voltage waveform data, the touch controller is configured to determine that the touch screen is touched when the corrected voltage waveform data is greater than preset standard data.

As such, since the touch controller is specifically used to determine the touch screen is touched, it will be more precise in practical detections.

According to a further aspect of the present invention, there is also provided a touch display device, the touch display device comprising the system for detecting a touch operation on a touch screen.

With the touch display device provided by the embodiment of the present invention, since the device comprises the system for detecting a touch operation on a touch screen, the touch display device provided by the embodiment of the present invention can precisely detect touch conditions, thereby effectively avoiding crosstalk on the touch signal caused by changes in voltage level in the TFT due to frame changes.

### BRIEF DESCRIPTION OF THE DRAWINGS

FIG. 1 is a schematic diagram of a liquid crystal display screen based on the in-cell touch technology in prior arts;

FIG. 2 is an operation flowchart of driving an in-cell liquid crystal screen in prior arts;

FIG. 3 is a flowchart of a touch detection method for a touch screen according to an embodiment of the present invention;

FIG. 4 is a schematic structural diagram of pixels of a liquid crystal panel according to an embodiment of the present invention;

FIG. 5 is a schematic diagram of a touch detection system for a touch screen according to an embodiment of the present invention;

FIG. 6 is a schematic diagram of an internal arrangement of a time schedule controller according to an embodiment of the present invention; and

FIG. 7 is system block diagram of a liquid crystal display screen based on the in-cell touch technology according to an embodiment of the present invention.

### DETAILED DESCRIPTION OF PREFERRED EMBODIMENTS OF THE INVENTION

A touch detection method and system for a touch screen and a touch display device of the present invention will be described hereinafter in detail in conjunction with preferred embodiments.

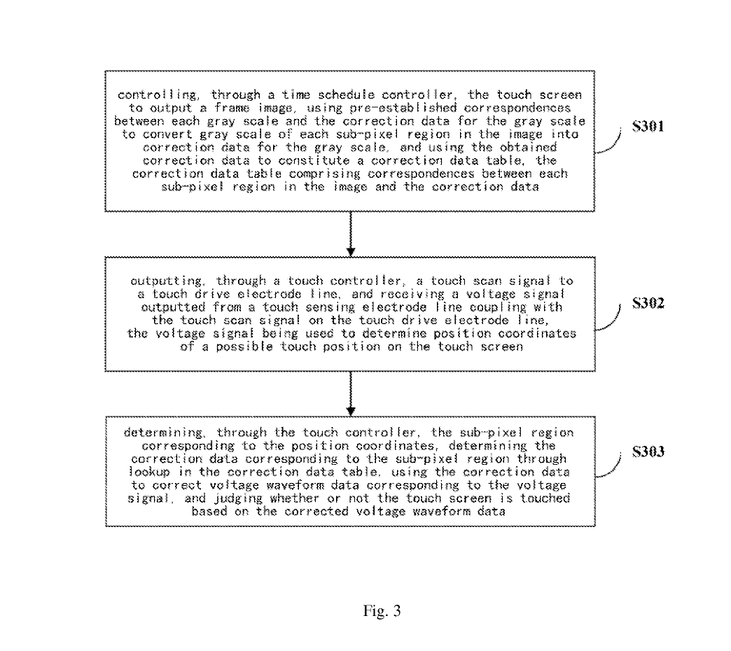

FIG. 3 shows a flowchart of a touch detection method for a touch screen, the method comprises:

S301: controlling, through a time schedule controller, the touch screen to output a frame image, using pre-established correspondences between each gray scale and the correction data for the gray scale to convert gray scale of each sub-pixel region in the image into correction data for the gray scale, and using the obtained correction data to constitute a correction data table, the correction data table comprising correspondences between each sub-pixel region in the image and the correction data;

S302: outputting, through a touch controller, a touch scan signal to a touch drive electrode line, and receiving a voltage signal outputted from a touch sensing electrode line coupling with the touch scan signal on the touch drive electrode line, the voltage signal being used to determine position coordinates of a possible touch position on the touch screen; and

S303: determining, through the touch controller, the sub-pixel region corresponding to the position coordinates, determining the correction data corresponding to the sub-pixel region through lookup in the correction data table, using the correction data to correct voltage waveform data corresponding to the voltage signal, and judging whether or not the touch screen is touched based on the corrected voltage waveform data.

The detection method shown in FIG. 3 will be described hereafter in detail in conjunction with a specific embodiment of the present invention.

In the specific embodiment of the present invention, an in-cell liquid display panel in an Advanced Super Dimension Switch (ADS) mode (that is, normally black mode) will be taken as an example. An in-cell capacitive touch liquid crystal display screen will be taken as an example of the touch screen in the specific embodiment of the present invention.

The specific embodiment of the present invention will be described by taking a liquid display panel having an 8-bit color depth as an example. A 8-bit liquid display panel has 256 gray scales each of which corresponds to a positive gray scale (Gamma) voltage and a negative gray scale voltage. A constant voltage Vcom is used as a common electrode voltage in an ADS liquid display panel; when the gray scale voltage within the liquid display panel is higher than the common electrode voltage Vcom, the gray scale voltage is called as a positive gray scale voltage; when the gray scale voltage within the liquid display panel is lower than the common electrode voltage Vcom, the gray scale voltage is called as a negative gray scale voltage. A set of positive and corresponding negative gray scale voltages can be used to drive liquid crystal molecules to obtain a corresponding gray scale. During a touch stage of the liquid display panel, the gray scale corresponding to each set of the gray scale voltages will affect touch detection regardless of positive and negative polarities of the gray scale voltages.

In the touch detection method for a touch screen according to the specific embodiment of the present invention, after the initialization of a system and a time schedule controller is finished, the time schedule controller controls the touch screen to output a preset image. Next, the touch controller outputs a touch scan signal to a touch drive electrode line, receives a voltage signal corresponding to a specific sub-pixel region outputted from a touch sensing electrode line coupling with the touch scan signal on the touch drive electrode line, and converts the received voltage signal into voltage waveform data, then saves the voltage waveform data in the touch controller as reference data. In an embodiment of the present invention, the preset image may be a black image or a white image, and of course, the preset image may be set to an image having different color(s) according practical detection conditions. The black image is taken as an example of the preset image in the specific embodiment of the present invention.

In an embodiment of the present invention, a gray scale voltage for each gray scale is used to drive a certain sub-pixel region of a touch screen. Touch controller outputs a touch scan signal to a touch drive electrode line, receives a voltage signal for the certain sub-pixel region outputted from a touch sensing electrode line coupling with the touch scan signal on the touch drive electrode line, thereby obtaining a voltage signal for the certain sub-pixel region corresponding to each gray scale. The touch controller converts the voltage signal for the certain sub-pixel region corresponding to each gray scale into corresponding voltage waveform data. For each voltage waveform data, a difference between the voltage waveform data and the reference data is used as correction data for the gray scale corresponding to the voltage waveform data so as to establish correspondences between each gray scale and the correction data for the gray scale. Since an 8-bit liquid display panel is used in the specific embodiment of the present invention, a total 256 correspondences can be obtained, as shown in table 1. Then, the obtained correspondences are saved in the time schedule controller. In practice detection, the correspondence in table 1 may be obtained by ways such as emulating and a number of tests; specifically, an oscilloscope may be used for testing, for example.

TABLE 1

| | gray scale | | | | |
|---|---|---|---|---|---|
| | 1 | 2 | . . . | 255 | 256 |
| correction data | A1 | A2 | . . . | A255 | A256 |

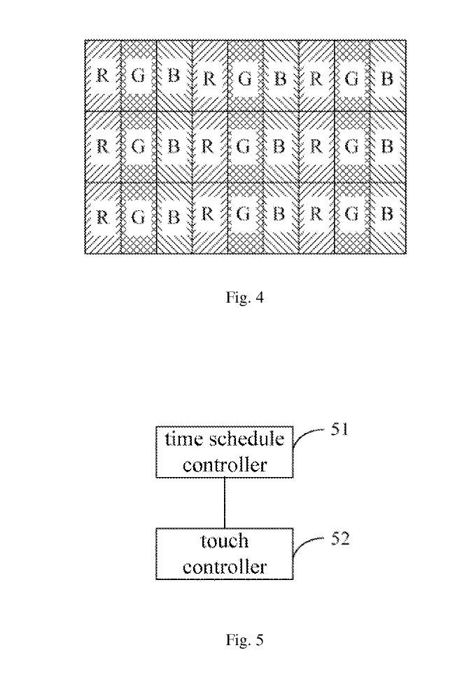

In an embodiment of the present invention, as shown in FIG. 4, it is assumed that the liquid display panel has a 3×3 resolution. There are 27 sub-pixels in all in the liquid display panel having a 3×3 resolution. Firstly, initializations of the system and the time schedule controller is performed, then the time schedule controller control a touch screen to output a black image. Next, the touch controller scans the black image. During the scan, the touch controller outputs a touch scan signal to a touch drive electrode line, receives a voltage signal corresponding to a particular sub-pixel region outputted from a touch sensing electrode line coupling with the touch scan signal on the touch drive electrode line, converts the received voltage signal into voltage waveform data, and uses the voltage waveform data as reference data. Then, the time schedule controller receives a data signal outputted from the system, controls the touch screen to output a frame image, converts gray scale of each of sub-pixel regions of the image into correction data for the corresponding gray scale by using a pre-established correspondence between each gray scale and the correction data for the gray scale, and constitutes a correction data table through using the obtained correction data, wherein the correction data table comprises correspondences between respective sub-pixel regions in the image and the correction data. In the specific embodiment of the present invention, the correction data may be calculated and obtained by various integrated circuit chips, as long as these integrated circuit chips can implement calculations of the correction data. Specifically, in an embodiment of the present invention, each sub-pixel corresponds to one gray scale thus the liquid display panel having a 3×3 resolution corresponds to 27 gray scales. For example, correspondences between sub-pixel regions and the correction data may be obtained through lookup in Table 1 of the specific embodiment of the present invention based on the gray scale of each sub-pixel, as shown in table 2.

TABLE 2

| | | | | | | | | |
|---|---|---|---|---|---|---|---|---|
| A1 | A1 | A1 | A8 | A255 | A90 | A32 | A47 | A88 |
| A95 | A106 | A248 | A36 | A24 | A55 | A254 | A254 | A254 |
| A75 | A45 | A32 | A66 | A69 | A156 | A123 | A35 | A65 |

The touch screen is touched and driven after finishing input of last row of gate signals of one frame image and before a next frame image is outputted, that is, within a blank period between two sequential frame images; at this time, the touch controller outputs a touch scan signal, and at the same time, receives a correction data table sent by the time schedule controller, for example, in the specific embodiment of the present invention, the correction data table is illustrated in table 2. The touch controller outputs a touch scan signal to a touch drive electrode line, receives a voltage signal outputted from a touch sensing electrode line coupling with the touch scan signal on the touch drive electrode line, and determines, based on the received voltage signal, position coordinates on the touch screen corresponding to the voltage signal; the touch controller determines the sub-pixel region corresponding to the position coordinates on the touch screen, determines the correction data corresponding to the sub-pixel region through lookup in the correction data table, uses the correction data to correct voltage waveform data corresponding to the voltage signal, and judges whether or not the touch screen is touched based on the corrected voltage waveform data.

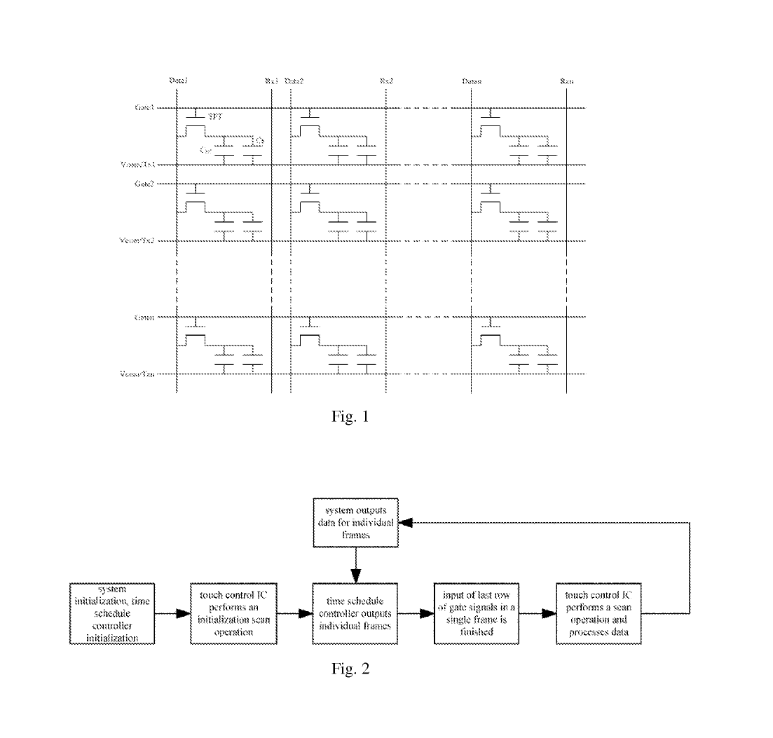

A process of judging whether or not the touch screen is touched will be described hereinafter with reference to FIG. 1.

As shown in FIG. 1, in the touch screen, each touch drive electrode line Tx will receive a touch scan signal, the touch controller receives a voltage signal outputted from the touch sensing electrode line Rx coupling with the touch scan signal on the touch drive electrode line Tx, and determines position coordinates on the touch screen corresponding to the voltage signal based on the received voltage signal. For example: the touch drive electrode line T1 receives a touch scan signal, the touch controller receives a voltage signal outputted from the touch sensing electrode line R1 coupling with the touch scan signal on the touch drive electrode line T1, and determines position coordinates on the touch screen corresponding to the voltage signal based on the received voltage signal (in this example, the position coordinates are those of a position where the touch drive electrode line T1 and the touch sensing electrode line R1 cross each other), the touch controller determines a sub-pixel region corresponding to the position coordinates on the touch screen (in this example, the sub-pixel region is a sub-pixel region located at the upper-left corner in FIG. 4 and corresponding to the position where the touch drive electrode line T1 and the touch sensing electrode line R1 cross each other), determines correction data corresponding to the sub-pixel region through lookup in the correction data table (in this example, it is assumed that the correction data corresponding to the sub-pixel region is A1), and uses the correction data to correct voltage waveform data corresponding to the voltage signal (in this example, it is assumed that the voltage waveform data corresponding to the voltage signal is B). In one exemplary embodiment, the touch controller subtracts the correction data A1 for the sub-pixel region corresponding to the position coordinates on the touch screen from the voltage waveform data B corresponding to the voltage signal to obtain a difference (B−A1), and uses the difference (B−A1) as the corrected voltage waveform data. When the corrected voltage waveform data (B−A1) is greater than a preset standard data such as data C, it is determined that the touch screen is touched. Herein, the preset standard data is set based on practical production conditions, and in practical detections, it is believed that a touch operation occurs when the data detected by the touch controller is greater than the preset standard data. The above operations are performed over and over again, and touch and display driving operations for the in-cell liquid crystal display screen can be achieved.

As shown in FIG. 5, the specific embodiment of the present invention further provides a touch detection system for a touch screen, the system comprises a time schedule controller 51 and a touch controller 52, wherein:

the time schedule controller 51 is configured to control the touch screen to output a frame image, convert gray scale of each of sub-pixel regions of the image into correction data for the gray scale by using pre-established correspondences between each gray scale and the correction data for the gray scale, and use the obtained correction data to constitute a correction data table, the correction data table comprising correspondences between each of the sub-pixel regions of the image and correction data; and

the touch controller 52 is configured to output a touch scan signal to a touch drive electrode line, and receive a voltage signal outputted from a touch sensing electrode line coupling with the touch scan signal on the touch drive electrode line, the voltage signal being used to determine position coordinates of a possible touch position on the touch screen; and the touch controller is further configured to determine the sub-pixel region corresponding to the position coordinates, determine the correction data corresponding to the sub-pixel region through lookup in the correction data table, use the correction data to correct voltage waveform data corresponding to the voltage signal, and judge whether or not the touch screen is touched based on the corrected voltage waveform data.

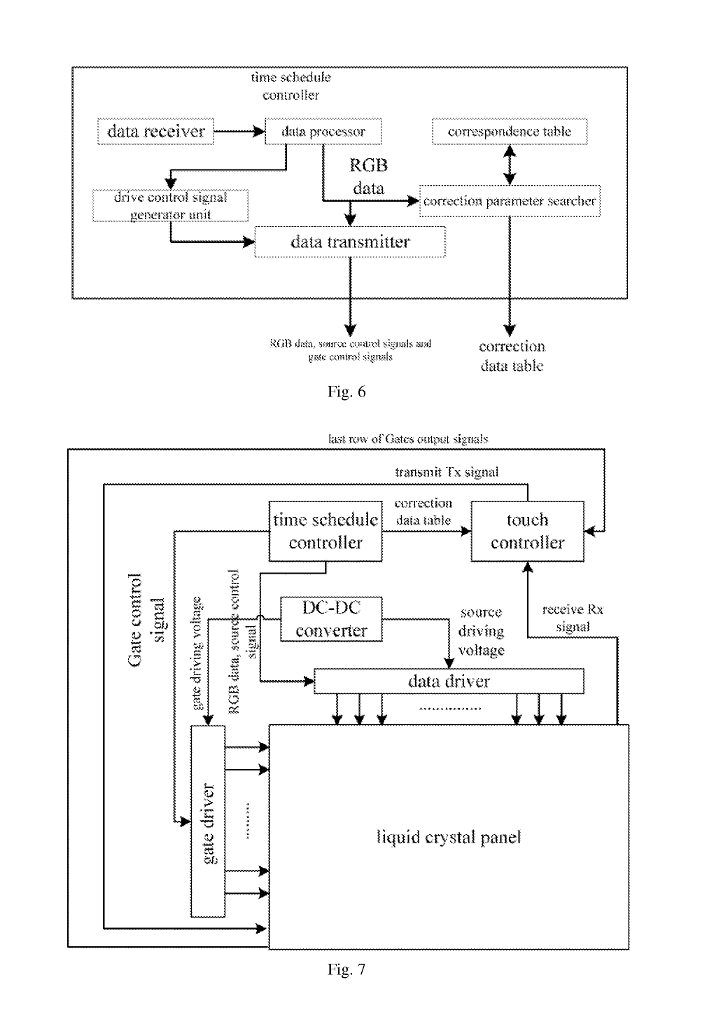

An internal arrangement of the time schedule controller 51 in the specific embodiment of the present invention is illustrated in FIG. 6. Wherein, the time schedule controller 51 comprises a data receiver unit, a data processor unit, a drive control signal generator unit, a correspondence table, a data transmitter unit and a correction parameter searcher unit. Wherein, the data transmitter unit is configured to transmit RGB data, source electrode control signals and gate electrode control signals. The correction parameter searcher unit is configured to transmit the correction data table.

A system block diagram of an in-cell touch liquid crystal display screen in the specific embodiment of the present invention is illustrated in FIG. 7. A relationship between the time schedule controller 51 and the touch controller 52, and relationships between the time schedule controller 51, the touch controller 52 and other units within the system are shown in the figure. As shown in FIG. 7, the data transmitter unit transmits RGB data and source electrode control signals to a data driver, and transmits gate electrode control signals to a gate electrode driving electrode. Further, the time schedule controller sends the correction data table to the touch controller through the correction parameter searcher (FIG. 6). The touch controller starts to control touch and drive operations for the liquid crystal panel after receiving a signal outputted from last row of gate electrodes of the liquid crystal panel, and the touch controller sends touch scan signals to the liquid crystal panel through touch drive electrode lines Tx, and receives, after the touch scan signals couple with signals on the touch sensing electrode lines, voltage signals from touch sensing electrode lines Rx, so as to judge whether or not the touch screen is touched.

It would be apparent that the person skilled in the art may make various changes or modifications to the present invention without departing from spirit and scopes of the disclosure. Thus, if these changes or modifications to the present invention fall within scopes of claims of the present invention and equivalents thereof, it is intended that the present invention includes these changes or modifications.

1. A method for detecting a touch operation on a touch screen, wherein the method comprises:
controlling the touch screen to output a frame image, using pre-established correspondences between each gray scale and correction data for the gray scale to convert the gray scale of each sub-pixel region in the image into the correction data for the gray scale, and using the obtained correction data to constitute a correction data table, the correction data table comprising correspondences between each sub-pixel region in the image and the correction data;
outputting a touch scan signal to a touch drive electrode line, and receiving a voltage signal outputted from a touch sensing electrode line coupling with the touch scan signal on the touch drive electrode line, the voltage signal being used to determine position coordinates of a possible touch position on the touch screen; and
determining the sub-pixel region corresponding to the position coordinates, determining the correction data corresponding to the sub-pixel region through lookup in the correction data table, using the correction data to correct voltage waveform data corresponding to the voltage signal, and judging whether or not the touch screen is touched based on the corrected voltage waveform data.

2. The method according to claim 1, further comprising a step of pre-establishing the correspondences between each gray scale and the correction data for the gray scale, the step comprising:
controlling the touch screen to output a preset image after an initialization of a time schedule controller is finished;
outputting a preset touch scan signal to a touch drive electrode line, receiving a reference voltage signal outputted from the touch sensing electrode line coupling with the preset touch scan signal on the touch drive electrode line, the reference voltage signal corresponding to a particular sub-pixel region, and converting the reference voltage signal into reference voltage waveform data, the reference voltage waveform data being used as reference data;
driving a certain sub-pixel of the touch screen through using a gray scale voltage for each gray scale, wherein a touch controller outputs the touch scan signal for each gray scale to the touch drive electrode line, and receives a gray scale voltage signal for the certain sub-pixel region outputted from the touch sensing electrode line coupling with the touch scan signal for each gray scale on the touch drive electrode line, so as to obtain the gray scale voltage signal for the certain sub-pixel region corresponding to each gray scale; and
converting the gray scale voltage signal for the certain sub-pixel region corresponding to each gray scale into gray scale voltage waveform data, and for each gray scale voltage waveform data, using a difference between the gray scale voltage waveform data and the reference voltage waveform data as correction data for the gray scale corresponding to the gray scale voltage waveform data so as to establish the correspondences between each gray scale and the correction data for the gray scale.

3. The method according to claim 2, wherein the preset image is a black image or a white image.

4. The method according to claim 1, wherein the step of using the correction data to correct voltage waveform data corresponding to the voltage signal comprises:
subtracting the correction data for the sub-pixel region corresponding to the position coordinates from the voltage waveform data corresponding to the voltage signal to obtain a difference, and using the difference as the corrected voltage waveform data.

5. The method according to claim 1, wherein the step of judging whether or not the touch screen is touched based on the corrected voltage waveform data comprises:
determining that the touch screen is touched when the corrected voltage waveform data is greater than preset standard data.

6. A system for detecting a touch operation on a touch screen, the system comprising a time schedule controller and a touch controller, wherein:
the time schedule controller is configured to control the touch screen to output a frame image, to use pre-established correspondences between each gray scale and correction data for the gray scale to convert the gray scale of each sub-pixel region in the image into the correction data for the gray scale, and to use the obtained correction data to constitute a correction data table, the correction data table comprising correspondences between each sub-pixel region in the image and the correction data; and
the touch controller is configured to output a touch scan signal to a touch drive electrode line, and to receive a voltage signal outputted from a touch sensing electrode line coupling with the touch scan signal on the touch drive electrode line, the voltage signal being used to determine position coordinates of a possible touch position on the touch screen; and the touch controller is further configured to determine the sub-pixel region corresponding to the position coordinates, to determine the correction data corresponding to the sub-pixel region through lookup in the correction data table, to use the correction data to correct voltage waveform data corresponding to the voltage signal, and to judge whether or not the touch screen is touched based on the corrected voltage waveform data.

7. The system according to claim 6, wherein
the time schedule controller is further configured to control the touch screen to output a preset image after an initialization of the time schedule controller is finished;
the touch controller is further configured to output a preset touch scan signal to a touch drive electrode line, to receive a reference voltage signal outputted from the touch sensing electrode line coupling with the preset touch scan signal on the touch drive electrode line, the reference voltage signal corresponding to a particular sub-pixel region, and convert the reference voltage signal into reference voltage waveform data, the reference voltage waveform data being used as reference data;
the touch controller is further configured to drive a certain sub-pixel of the touch screen through using a gray scale voltage for each gray scale, wherein the touch controller outputs the touch scan signal for each gray scale to the touch drive electrode line, and receives a gray scale voltage signal for the certain sub-pixel region outputted from the touch sensing electrode line coupling with the touch scan signal for each gray scale on the touch drive electrode line, so as to obtain the gray scale voltage signal for the certain sub-pixel region corresponding to each gray scale; and
the touch controller is further configured to convert the gray scale voltage signal for the certain sub-pixel region corresponding to each gray scale into gray scale voltage waveform data, and for each gray scale voltage waveform data, use a difference between the gray scale voltage waveform data and the reference voltage waveform data as correction data for the gray scale corresponding to the gray scale voltage waveform data so as to establish the correspondences between each gray scale and the correction data for the gray scale.

8. The system according to claim 6, wherein, when using the correction data to correct voltage waveform data corresponding to the voltage signal,
the touch controller is configured to subtract the correction data for the sub-pixel region corresponding to the position coordinates from the voltage waveform data corresponding to the voltage signal to obtain a difference, and use the difference as the corrected voltage waveform data.

9. The system according to claim 6, wherein, when judging whether or not the touch screen is touched based on the corrected voltage waveform data, the touch controller is configured to determine that the touch screen is touched when the corrected voltage waveform data is greater than preset standard data.

10. A touch display device, comprising a system for detecting a touch operation on a touch screen, the system comprising a time schedule controller and a touch controller, wherein:
the time schedule controller is configured to control the touch screen to output a frame image, to use pre-established correspondences between each gray scale and correction data for the gray scale to convert the gray scale of each sub-pixel region in the image into the correction data for the gray scale, and to use the obtained correction data to constitute a correction data table, the correction data table comprising correspondences between each sub-pixel region in the image and the correction data; and
the touch controller is configured to output a touch scan signal to a touch drive electrode line, and to receive a voltage signal outputted from a touch sensing electrode line coupling with the touch scan signal on the touch drive electrode line, the voltage signal being used to determine position coordinates of a possible touch position on the touch screen; and the touch controller is further configured to determine the sub-pixel region corresponding to the position coordinates, to determine the correction data corresponding to the sub-pixel region through lookup in the correction data table, to use the correction data to correct voltage waveform data corresponding to the voltage signal, and to judge whether or not the touch screen is touched based on the corrected voltage waveform data.

11. The touch display device according to claim 10, wherein
the time schedule controller is further configured to control the touch screen to output a preset image after an initialization of the time schedule controller is finished;
the touch controller is further configured to output a preset touch scan signal to a touch drive electrode line, to receive a reference voltage signal outputted from the touch sensing electrode line coupling with the preset touch scan signal on the touch drive electrode line, the reference voltage signal corresponding to a particular sub-pixel region, and convert the reference voltage signal into reference voltage waveform data, the reference voltage waveform data being used as reference data;
the touch controller is further configured to drive a certain sub-pixel of the touch screen through using a gray scale voltage for each gray scale, wherein the touch controller outputs the touch scan signal for each gray scale to the touch drive electrode line, and receives a gray scale voltage signal for the certain sub-pixel region outputted from the touch sensing electrode line coupling with the touch scan signal for each gray scale on the touch drive electrode line, so as to obtain the gray scale voltage signal for the certain sub-pixel region corresponding to each gray scale; and
the touch controller is further configured to convert the gray scale voltage signal for the certain sub-pixel region corresponding to each gray scale into gray scale voltage waveform data, and for each gray scale voltage waveform data, use a difference between the gray scale voltage waveform data and the reference voltage waveform data as correction data for the gray scale corresponding to the gray scale voltage waveform data so as to establish the correspondences between each gray scale and the correction data for the gray scale.

12. The touch display device according to claim 10, wherein, when using the correction data to correct voltage waveform data corresponding to the voltage signal, the touch controller is configured to subtract the correction data for the sub-pixel region corresponding to the position coordinates from the voltage waveform data corresponding to the voltage signal to obtain a difference, and use the difference as the corrected voltage waveform data.

13. The touch display device according to claim 10, wherein, when judging whether or not the touch screen is touched based on the corrected voltage waveform data, the touch controller is configured to determine that the touch screen is touched when the corrected voltage waveform data is greater than preset standard data.
